(19) United States
(12) Patent Application Publication
(10) Pub. No.: US 2024/0214915 A1
(43) Pub. Date: Jun. 27, 2024

(54) METHOD AND APPARATUS FOR MANAGING SWITCHING BETWEEN ACCESS OPERATION MODES OF USER EQUIPMENT

(71) Applicant: Samsung Electronics Co., Ltd., Gyeonggi-do (KR)

(72) Inventors: Vijay Kumar MISHRA, Bangalore (IN); Lalith KUMAR, Bangalore (IN); Govind UTTUR, Bangalore (IN); Danish Ehsan HASHMI, Bangalore (IN); Utsav SINHA, Bangalore (IN)

(21) Appl. No.: 18/392,387

(22) Filed: Dec. 21, 2023

(30) Foreign Application Priority Data
Dec. 21, 2022 (IN) 202241074299
Dec. 4, 2023 (IN) 202241074299

(51) Int. Cl. H04W 48/18; H04W 48/02; H04W 60/00

(52) U.S. Cl. CPC H04W 48/18; H04W 48/02; H04W 60/00; H04W 84/042

(57) ABSTRACT

The disclosure relates to a 5G or 6G communication system for supporting a higher data transmission rate. A method performed by a terminal in a wireless communication system is provided. Information on a stand-alone non-public network (SNPN) may be stored in at least one list of one or more forbidden SNPNs, while operating in an SNPN access operation mode. The SNPN access operation mode may be deactivated. The at least one list of one or more forbidden SNPNs may be maintained.

### CROSS-REFERENCE TO RELATED APPLICATION(S)

This application is based on and claims priority under 35 U.S.C. § 119 to Indian Provisional Patent Application No. 202241074299, filed on Dec. 21, 2022, and Indian Patent Complete Application No. 202241074299, filed on Dec. 4, 2023, in the Indian Patent Office, the disclosures of which are incorporated herein by reference in their entirety.

### BACKGROUND

### 1. Field

The present disclosure relates generally to telecommunication networks. More particularly, to a method and a user equipment (UE) for managing switching between access operation modes of the UE.

### 2. Description of Related Art

5^{th} generation (5G) mobile communication technologies define broad frequency bands such that high transmission rates and new services are possible, and can be implemented not only in “Sub 6 GHz” bands such as 3.5 gigahertz (GHz), but also in “Above 6 GHz” bands referred to as mmWave, including 28 GHz and 39 GHz. In addition, 6^{th} generation (6G) mobile communication technologies (referred to as Beyond 5G systems) may be implemented in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologics (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for a large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, NR UE Power Saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Currently, there are needs to enhance switching between access operation modes of a terminal in wireless communication system.

In an embodiment, a method performed by a terminal in a wireless communication system is provided. Information on a standalone non-public network (SNPN) may be stored in at least one list of one or more forbidden SNPNs, while operating in an SNPN access operation mode. The SNPN access operation mode may be deactivated. The at least one list of one or more forbidden SNPNs may be maintained.

In an embodiment, a method performed by a terminal in a wireless communication system is provided. Information on a public land mobile network (PLMN) may be stored in at least one list of one or more forbidden PLMNs. An SNPN access operation mode may be activated. The at least one list of one or more forbidden PLMNs may be maintained.

In an embodiment, a terminal in a wireless communication system is provided. The terminal includes a transceiver and a controller coupled with the transceiver. The controller may be configured to store information on an SNPN in at least one list of one or more forbidden SNPNs., deactivate an SNPN access operation mode, and maintain the at least one list of one or more forbidden SNPNs.

In an embodiment, a terminal in a wireless communication system is provided. The terminal includes a transceiver and a controller coupled with the transceiver. The controller may be configured to store information on a PLMN in at least one list of one or more forbidden PLMNs, activate an SNPN access operation mode, and maintain the at least one list of one or more forbidden PLMNs.

In an embodiment, the present disclosure discloses a method of managing switching between access operation modes of a User Equipment (UE). The method comprises detecting a switching from a SNPN access operation mode to a not in SNPN access operation mode. Further, the method comprises maintaining a plurality of forbidden lists of the SNPN access operation mode and execution of a timer initiated during the SNPN access operation mode, in the UE. Thereafter, the method comprises managing the switching between the SNPN access operation mode and the not in SNPN access operation mode, by removing the plurality of forbidden lists of the SNPN access operation mode, upon the expiry of the timer in one of, the SNPN access operation mode and the not in SNPN access operation mode.

In an embodiment, the present disclosure discloses a method of managing switching between access operation modes of a User Equipment (UE). The method comprises detecting a switching from a not in SNPN access operation mode to a SNPN access operation mode. Further, the method comprises maintaining a plurality of forbidden lists of the not in SNPN access operation mode and execution of a timer initiated during the not in SNPN access operation mode, in the UE. Thereafter, the method comprises managing the switching between the SNPN access operation mode and not in SNPN access operation mode, by removing the plurality of forbidden lists of the not in SNPN access operation mode, upon the expiry of the timer in one of the SNPN access operation mode and the not in SNPN access operation mode.

In an embodiment, the present disclosure discloses a User Equipment (UE) for managing switching between access operation modes. The UE comprises a processor and a memory. The processor is configured to detect a switching from a not in SNPN access operation mode to a SNPN access operation mode. Further, the processor is configured to maintain a plurality of forbidden lists of the not in SNPN access operation mode and execution of a timer initiated during the not in SNPN access operation mode, in the UE. Thereafter, the processor is configured to manage the switching between the SNPN access operation mode and not in SNPN access operation mode, by removing the plurality of forbidden lists of the not in SNPN access operation mode, upon the expiry of the timer in one of the SNPN access operation mode and the not in SNPN access operation mode.

In an embodiment, the present disclosure discloses a User Equipment (UE) for managing switching between access operation modes. The UE comprises a processor and a memory. The processor is configured to detect a switching from a not in SNPN access operation mode to an SNPN access operation mode. Further, the processor is configured to maintain a plurality of forbidden lists of the not in SNPN access operation mode and execution of a timer initiated during the not in SNPN access operation mode, in the UE. Thereafter, the processor is configured to manage the switching between the SNPN access operation mode and not in SNPN access operation mode, by removing the plurality of forbidden lists of the not in SNPN access operation mode, upon the expiry of the timer in one of the SNPN access operation mode and the not in SNPN access operation mode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating the managing of switching between access operation modes of a User Equipment (UE), according to an embodiment;

FIG. 2 is a diagram illustrating a UE for managing switching between the access operation modes, according to an embodiment;

FIG. 3A is a flowchart illustrating a method for managing switching from a SNPN access operation mode to a not in SNPN access operation mode, according to an embodiment;

FIG. 3B is a flowchart illustrating a method for managing switching from a not in SNPN access operation mode to a SNPN access operation mode, according to an embodiment;

FIG. 4 is a flowchart illustrating a method for managing switching from an SNPN access operation mode to a not in SNPN access operation mode, according to an embodiment;

FIG. 5 is a flowchart illustrating a method for managing switching from a not in SNPN access operation mode to an SNPN access operation mode, according to an embodiment;

FIG. 6 is a diagram illustrating a general-purpose computing system for managing switching between the access operation modes of the UE, according to an embodiment;

FIG. 7 is a diagram illustrating a structure of a UE or terminal, according to an embodiment;

FIG. 8 is a diagram illustrating a structure of a base station (BS), according to an embodiment; and

FIG. 9 is a diagram illustrating a structure of a network entity, according to an embodiment.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

Herein, the term “exemplary” is used herein to mean serving as an example, instance, or illustration. Any embodiment or implementation described herein as exemplary is not necessarily to be construed as preferred or advantageous over other embodiments.

While the disclosure may take various modifications and alternative forms, specific embodiments thereof have been shown by way of example in the drawings and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Private networks or non-public networks (NPNs) are intended for non-public or private use. The private networks are implemented in, for example, hospitals, industries, enterprises, stadiums, and the like. 3rd generation partnership project (3GPP) specifications support various configurations of NPNs. While there are many possible configurations of the NPNs, 3GPP defines two major categories of the NPNs: SNPN and public network integrated NPN (PNI-NPN). SNPN refers to an NPN that is operated by an NPN operator and does not rely on network functions provided by a PLMN. The PNI-NPN is a non-public network deployed with the support of the PLMN.

The 3GPP specifications define two access operation modes for a UE. The UE can operate in SNPN access operation mode or out of the SNPN access operation mode. The UE capable of operating in the SNPN access operation mode camps onto a SNPN and receives various services provided by the NPN operator via the SNPN. When the UE is not SNPN enabled, the UE is considered to be not operating in the SNPN access operation mode (also referred to as not in SNPN access operation mode). In such case, the UE performs PLMN selection and receives services provided by a PLMN operator. When the UE is SNPN enabled, the UE can operate in the SNPN access operation mode.

Currently, as per the 3GPP specifications, UE behavior is defined for the SNPN access operation mode and not in SNPN access operation mode. The 3GPP specifications require the UE to maintain specific access operation modes for configuring functionalities and receiving services from a network. There are specifications for management of forbidden lists (both temporary and permanent reject causes) and related timers, when the UE interacts with the network. For example, TS24.501 specifies managing available SNPNs present in a list of temporarily forbidden SNPNs or a list of permanently forbidden SNPNs for an entry of a list of subscriber data. The 3GPP specifications also specify a forbidden PLMN list or a forbidden PLMNs for general packet radio service (GPRS) service list for an entry of the list of subscriber data or the PLMN subscription. In the SNPN access operation mode, the UE can select only SNPNs, and not PLMNs for any service. An SNPN is added to either of the forbidden lists, when the UE receives a registration reject, a service reject, a network initiated de-registration request, and/or the like. When the SNPN is present in either of the forbidden lists, the UE in the SNPN access operation mode cannot select the SNPN for normal services. When an SNPN is added to either of the forbidden lists, the UE is required to start a timer (e.g., T3245). The forbidden lists are cleared when the timer expires.

There are no clear procedures in the 3GPP specifications on the UE behavior with respect to handling the timer and the forbidden lists of the SNPN access operation mode, when the UE switches from the SNPN access operation mode to the not in SNPN access operation mode. Similarly, there are no clear procedures in the 3GPP specifications on the UE behavior with respect to handling the timer and the forbidden lists of the not in SNPN access operation mode, when the UE switches from the not in SNPN access operation mode to the SNPN access operation mode.

The information disclosed in this background of the disclosure section is only for enhancement of understanding of the general background of the invention and should not be taken as an acknowledgement or any form of suggestion that this information forms the prior art already known to a person skilled in the art.

Private networks or Non-Public Networks (NPNs) are intended for the non-public or private use. SNPN refers to an NPN that is operated by an NPN operator and does not rely on network functions provided by a Public Land Mobile Network (PLMN). The UE can operate in SNPN access operation mode or out of the SNPN access operation mode. Currently, as per the 3GPP specifications, UE behavior is defined for the SNPN access operation mode and not in SNPN access operation mode. There are specifications for management of forbidden lists (both temporary and permanent reject causes) and related timers. However, there are no clear procedures in the 3GPP specifications on the UE behavior with respect to handling the timer and the forbidden lists of the SNPN access operation mode, when the UE switches between access operation modes.

The present disclosure provides a method and a UE for managing switching between access operation modes of the UE. The present disclosure provides a solution for maintaining forbidden lists of SNPNs or PLMNs when the UE switches between SNPN access operation mode and not in SNPN access operation mode. Also, the present disclosure provides a solution for maintaining execution of a timer initiated during the SNPN access operation mode or PLMN access operation mode, and deletion of respective forbidden lists, upon expiry of the timer irrespective of the access operation mode. Accordingly, the switching between the access operation modes of the UE is managed. The present disclosure enables the UE to select a SNPN or a PLMN present in the forbidden lists when the UE switches back to respective access operation mode.

The present subject matter relates generally to a field of wireless communication, more particularly, the present subject matter relates to switching of operation access modes by a user equipment.

Stand-alone Non-Public Network (SNPN) is operated by an NPN operator and does not rely on network functions provided by a PLMN, or a public network integrated NPN (PNI-NPN), being a non-public network deployed with the support of a PLMN. At present, 3GPP specifications have defined two operating modes for UEs (User Equipment). They can operate in SNPN access operation mode or out of SNPN access operation mode (for example when UE performs PLMN selection, it is referred to as, but not limited to, PLMN Mode) which can be termed as non-SNPN access mode or non-SNPN access operation mode. A UE capable of operating in SNPN access mode, camps onto a SNPN and receives various services provided by the NPN operator to the UE via the SNPN. If the UE is not SNPN enabled, the UE is always considered to be not operating in SNPN access operation mode i.e., in non-SNPN access operation mode or operating in non-SNPN access mode. If the UE is SNPN enabled, the UE can operate in SNPN access operation mode. Details of activation and deactivation of SNPN access operation mode at the SNPN enabled UE are based on UE implementation.

As per 3GPP specifications, UE behavior is defined for standalone SNPN access operation mode and/or non SNPN access operation mode. 3GPP specification requires the UE to maintain specific access operation modes for its functionalities and services from the network. However, there is no clarity on UE behavior with respect to certain events when the UE switches between the available access mode of operations. As per 3GPP, there are specifications for management of forbidden lists (both temporary and permanent reject causes) and their related timers when the UE interacts with the network. For example, TS24.501 specifies managing available SNPNs present in a list of temporarily forbidden SNPNs or a list of permanently forbidden SNPNs for an entry of the list of subscriber data or the PLMN subscription. 3GPP specifications also specified about entries and list of temporarily forbidden SNPNs or a list of permanently forbidden SNPNs or forbidden PLMN list or forbidden PLMNs for GPRS service list for an entry of the list of subscriber data or the PLMN subscription when the UE switches off or is restarted. However, if the UE decides to perform access operation mode switch between its two available operating access modes, via SNPN access operation mode to non SNPN access operation mode or vice versa, then UE will not be able to manage above said lists which are applicable to a specific mode or common to both modes, when it switches to another mode.

Embodiments disclose handling of UE behavior in line with 3GPP technical specifications so as to make them reasonable and acceptable with respect to the 3GPP standards. The UE is able to manage entries of SNPN or PLMN in the list of temporarily forbidden SNPNs or a list of permanently forbidden SNPNs or forbidden PLMN list or forbidden PLMNs for GPRS service list for an entry of the list of subscriber data or the PLMN subscription. Additionally, UE behavior is specified with respect to timers (exemplified by but not limited to T3245, etc.) associated with these respective lists.

The UE is capable of operating in an SNPN access operation mode and a non SNPN operation mode. The UE chooses to operate in a particular access mode, performs access operation mode specific selection, and maintains specific forbidden lists and timers. The UE and an access and mobility management function (AMF) perform SNPN/PLMN selection and registration. Due to some trigger, the UE may switch access operation mode. As the UE switches access operation mode, there is no clarity regarding whether to maintain a forbidden list and timers for a previous access operation mode or not. The UE and the AMF perform PLMN/SNPN selection and registration.

In an aspect of the disclosure, clear entries are provided in respective forbidden list and timers. The UE may be capable of operating in an SNPN access operation mode and switching modes from the SNPN access operation mode to a non-SNPN access operation mode. Herein, the UE may delete all entries in the list of temporarily forbidden SNPNs or the list of permanently forbidden SNPNs for all entries of the list of subscriber data. If there is any running timer related to a list of temporarily forbidden SNPNs or the list of permanently forbidden SNPNs, either specific to the SNPN access operation mode or common to both operating modes (exemplified by but not limited to T3245, etc.), then that timer may be stopped. Any implementation specific timer, related to the SNPN access operation mode may also be stopped. If there are any non-zero retry counters, either specific to the SNPN access mode or common to both operating modes, then they may be reset to 0.

The UE is capable of an SNPN access operation mode and a non-SNPN operation mode. The UE chooses to operate in the SNPN access operation mode, performs SNPN selection, and maintains SNPN specific forbidden lists and timers. The UE and an AMF perform SNPN selection and registration. Due to some trigger, the UE switches from the SNPN access operation mode to the non-SNPN access operation mode. As the UE is out of the SNPN access operation mode, the UE shall clear the forbidden lists specific to the SNPN access operation mode and clear retry counters, and stop timers specific to SNPN or common to both modes if running (ex. T3245). The UE and the AMF perform PLMN selection and registration.

In another embodiment, the UE may be capable of operating in an SNPN access operation mode, and switches modes from the non-SNPN access operation mode to the SNPN access operation mode. Herein, the UE may delete all entries in the forbidden PLMN list or the forbidden PLMNs for GPRS service list for the PLMN subscription. If there is any running timer related to the forbidden PLMN list or the list of forbidden PLMNs for GPRS service, either specific to the non-SNPN access operation mode or common to both operating modes (exemplified by but not limited to T3245, etc.), then that timer may be stopped. Any implementation specific timer, related to the SNPN access operation mode may also be stopped. If there are any non-zero retry counters, either specific to the SNPN access operation mode or common to both operating modes, then they may be reset to 0.

The UE is capable of the SNPN access operation mode and the non-SNPN access operation mode. The UE chooses to operate in the non-SNPN access operation mode, performs PLMN selection, and maintains PLMN specific forbidden lists and timers. The UE and an AMF perform PLMN selection and registration. Due to some trigger, the UE switches from the non-SNPN access operation mode to the SNPN access operation mode. As the UE is now in the SNPN access operation mode, the UE may clear the forbidden lists specific to the non-SNPN access operation mode, clear all retry counters and stop all timers specific to the non-SNPN access operation mode or common to both modes, if running (ex. T3245). The UE and the AMF may perform SNPN selection and registration.

In another aspect of the disclosure, entries may be maintained in respective forbidden list and timers. The UE may be capable of operating in the SNPN access operation mode, and switches modes from the SNPN access operation mode to the non-SNPN access operation mode. Herein, the UE may store and maintain all entries in the list of temporarily forbidden SNPNs or the list of permanently forbidden SNPNs for all entries of the list of subscriber data. If there is any running timer related to the list of temporarily forbidden SNPNs or the list of permanently forbidden SNPNs, either specific to the SNPN access operation mode or common to both operating modes (exemplified by but not limited to T3245, etc.), then that timer may be maintained (i.e., continues to run). Any implementation specific timer, related to the SNPN access operation mode may also be maintained. If there are any non-zero retry counters, either specific to the SNPN access operation mode or common to both operating modes, then they may be maintained.

The UE is capable of the SNPN access operation mode and the non-SNPN access operation mode. The UE chooses to operate in the SNPN access operation mode, performs SNPN selection, and maintains SNPN specific forbidden lists and timers. The UE and an AMF perform SNPN selection and registration. Due to some trigger, the UE switches from the SNPN access operation mode to the non-SNPN access operation mode. As the UE is out of the SNPN access operation mode, the UE shall maintain the forbidden lists specific to the SNPN access operation mode, and retry counters and timers specific to SNPN or common to both modes, if running (e.g., T3245). The UE and the AMF perform PLMN selection and registration. The maintained and running timer is expired. The UE may reset retry counters and delete forbidden lists using the below exemplary logic:

If (running timer is specific to non-SNPN access mode)
Delete all entries from list of ″temporarily forbidden SNPNs″ and the list of
″permanently forbidden SNPNs”
If (running timer is common to both access modes) {
Delete all entries from list of ″temporarily forbidden SNPNs″ and the list of
″permanently forbidden SNPNs”
Delete all entries from the ″forbidden PLMN list″ or list of “forbidden PLMNs for
GPRS service”}

In another embodiment, the UE may be capable of operating in the SNPN access operation mode, and switches modes from the non-SNPN access operation mode to the SNPN access operation mode. Herein, the UE may store and maintain all entries in the forbidden PLMN list or forbidden PLMNs for a GPRS service list. If there is any running timer related to forbidden PLMN list or the list of forbidden PLMNs for GPRS service list, either specific to the non-SNPN access operation mode or common to both operating modes (exemplified by but not limited to T3245, etc.), then that timer may be maintained (i.e., continues to run). Any implementation specific timer, related to the SNPN access operation mode may also be maintained. If there are any non-zero retry counters, either specific to the SNPN access operation mode or common to both operating modes, then they may be maintained.

The UE is capable of the SNPN access operation mode and the non-SNPN access operation mode. The UE chooses to operate in the non-SNPN access operation mode, performs PLMN selection, and maintains PLMN specific forbidden lists and timers. The UE and an AMF perform PLMN selection and registration. Due to some trigger, the UE switches from the non-SNPN access operation mode to the SNPN access operation mode. As the UE is now in the SNPN access operation mode, the UE may maintain the forbidden lists specific to the non-SNPN access operation mode, and retry counters and all timers specific to the non-SNPN or common to both modes, if running (ex. T3245). The UE and the AMF perform SNPN selection and registration. The maintained and running timer is expired. The UE may reset retry counters and delete forbidden lists using the below exemplary logic:

If (running timer is specific to SNPN access mode)
Delete all entries from the ″forbidden PLMN list″ or list of “forbidden PLMNs for
GPRS service”
If (running timer is common to both access modes) {
Delete all entries from list of ″temporarily forbidden SNPNs″ and the list of
″permanently forbidden SNPNs”
Delete all entries from the ″forbidden PLMN list″ or list of “forbidden PLMNs for
GPRS service”}

Moreover, the UE may be capable of operating in the SNPN access operation mode, and switching modes from the SNPN access operation mode to the non-SNPN access operation mode or vice versa. Herein, the entries in the list of temporarily forbidden SNPNs or forbidden PLMN list or the list of permanently forbidden SNPNs or forbidden PLMNs for GPRS service list for an entry of the list of subscriber data or the PLMN subscription, may be needed to be maintained along with the respective timers (exemplified by but not limited to T3245, etc.). For these lists, the below logic (explained with timer T3245 example), can be used to maintain those timers.

For example, T3245 continues to run when the UE switches between its two available operation access modes. If the UE operation access mode is switched when the timer T3245 is running, the UE may behave as follows. That is, when the UE is switched back to a previous access operation mode and a selected SNPN subscription remains same, let t1 be the time remaining for T3245 timeout at access operation mode switch and let t be the time elapsed between access operation switch and a return to same access operation mode. If t1 is greater than t, then the timer shall be restarted with the value t1−t. If t1 is less than or equal to t, then the UE may follow the behavior as defined in the paragraph above upon expiry of the timer T3245. If the UE is not capable of determining t, then the UE shall restart the timer with the value t1.

In yet another embodiment, implementation dependent timers and T3245 may continue to run when a change (or switch) in access operation modes is performed, and they may also follow above-described logic. Moreover, there may be multiple possibilities for UE behavior when the timers expire.

In an embodiment, when a timer specific to the SNPN access mode expires, the UE may erase the permanently forbidden SNPNs list(s) and temporarily forbidden SNPNs list(s) and set the selected entry of the list of subscriber data or the selected PLMN subscription to be valid for 3GPP access and non-3GPP access. When the lists are erased, the UE performs cell selection according to 3GPP TS 38.304. This deletion/erasing is to be performed immaterial of the current operating access mode of the UE.

In an embodiment, when a timer specific to the non-SNPN access mode expires, the UE may erase the forbidden PLMN list and forbidden PLMNs for GPRS service list and set the USIM to valid for 5GS services for 3GPP access and non-3GPP access. When the lists are erased, the UE performs cell selection according to 3GPP TS 38.304 or 3GPP TS 36.304 [25C]. This deletion/erasing may be performed immaterial of the current operation access mode of the UE.

In an embodiment, when a timer common to both modes (only single instance running for both SNPN and PLMN, Like T3245) expires, the UE may erase permanently forbidden SNPNs list(s) and temporarily forbidden SNPNs list(s), the forbidden PLMN list and forbidden PLMNs for GPRS service list and set the USIM or the selected entry of the list of subscriber data or the selected PLMN subscription to valid for 3GPP access and non-3GPP access based on current UE operating access mode. This deletion/erasing may be performed immaterial of the current operating access mode of the UE.

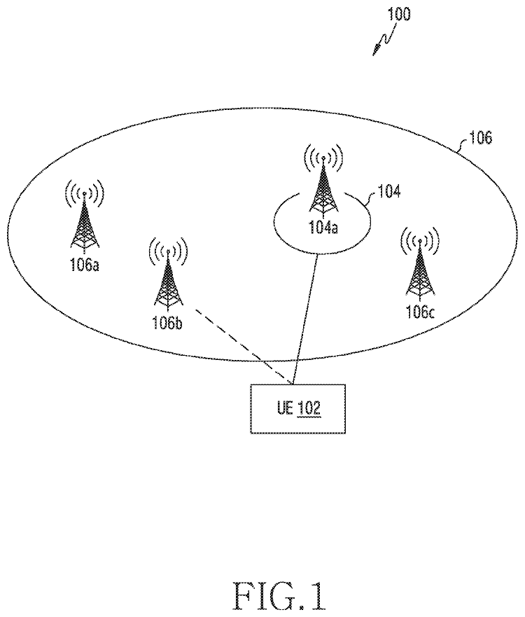

FIG. 1 is a diagram illustrating an exemplary environment for managing switching between access operation modes of a UE, according to an embodiment. An exemplary environment 100 comprises a UE 102 and a plurality of networks, including a SNPN 104a and PLMNs 106a, 106b, and 106c. Embodiments relate to managing switching between the access operation modes of the UE 102. The UE 102 may be any device configured to communicate in a wireless network in an SNPN access mode. Examples of the UE 102 include, but are not limited to, mobile phones, smartphones, laptops, wearables, and the like.

SNPN refers to an NPN that is operated by an NPN operator and does not rely on network functions provided by a PLMN. The UE 102 may operate in the SNPN access operation mode or out of the SNPN access operation mode. When the UE 102 operates out of the SNPN access operation mode, such a mode is termed as “not in SNPN access operation mode”. As shown in FIG. 1, the UE 102 capable of operating in an SNPN access operation mode 104 camps onto the SNPN 104a and receives various services provided by the NPN operator via the SNPN 104a. When the UE 102 is not operating in the SNPN access operation mode 104, the UE 102 may be switched to not in SNPN access operation mode 106. In such case, the UE 102 may perform PLMN selection and receives services provided by a PLMN operator via PLMNs 106a, 106b, 106c. The number of SNPNs and PLMNs shown in FIG. 1 are shown for exemplary purposes only.

Herein, the UE 102 is configured to manage switching between the access operation modes. The UE 102 may detect a switching from the SNPN access operation mode 104 to the not in SNPN access operation mode 106. The UE 102 switches from the SNPN access operation mode 104 to the not in SNPN access operation mode 106, when the SNPN access operation mode 104 is deactivated. For example, the UE 102 may move out from the SNPN 104a to the PLMN 106a. The UE 102 may have a plurality of forbidden lists of the SNPN access operation mode 104.

The plurality of forbidden lists of the SNPN access operation mode 104 may include a permanently forbidden SNPNs list, a temporarily forbidden SNPNs list managed per access type independently, a permanently forbidden SNPNs list for network onboarding services, and a temporarily forbidden SNPNs list for network onboarding services. An SNPN may be added to a forbidden list, when the UE 102 receives a registration reject, a service reject, or a network initiated de-registration request, with cause value #74 (temporarily not authorized for this SNPN) or #75 (permanently not authorized for this SNPN). When the SNPN is in the plurality of forbidden lists, the UE 102 cannot select the SNPN for normal services, when operating in the SNPN access operation mode 104. When the SNPN is added to the one of the plurality of lists, the UE 102 is required to start a timer (e.g., T3245). The plurality of forbidden lists is cleared when the timer expires. Referring to the above-described example, the UE 102 may have SNPN 104b (not shown) in the plurality of forbidden lists when operating in the SNPN access operation mode 104. However, as per current 3GPP specifications, there is no trigger to remove the plurality of forbidden lists when the UE 102 switches from the SNPN access operation mode 104 to the not in SNPN access operation mode 106. Referring to the above-described example, the plurality of forbidden lists including the SNPN 104b may not be removed. In such case, the UE 102 may not be able to select the SNPN 104b, when the UE 102 switches back to the SNPN access operation mode 104.

Herein, the UE 102 is configured to maintain the plurality of forbidden lists of the SNPN access operation mode 104 and execution of the timer initiated during the SNPN access operation mode 104, in the UE 102. Herein, the UE 102 may continue execution of the timer initiated during the SNPN access operation mode 104, and store the plurality of forbidden lists of the SNPN access operation mode 104. Then, the UE 102 may remove the plurality of forbidden lists of the SNPN access operation mode 104, upon expiry of the timer in the SNPN access operation mode 104 or the not in SNPN access operation mode 106. In this way, the UE 102 is able to select the SNPN 104b, when operating in the SNPN access operation mode 104.

In an embodiment, the UE 102 may detect a switching from the not in SNPN access operation mode 106 to the SNPN access operation mode 104. The UE 102 switches from the not in SNPN access operation mode 106 to the SNPN access operation mode 104, when the SNPN access operation mode 104 is activated. For example, the UE 102 may move out from the PLMN 106a to the SNPN 104a. The UE 102 may have a plurality of forbidden lists of the not in SNPN access operation mode 106.

The plurality of forbidden lists of the not in SNPN access operation mode 106 may include lists of forbidden PLMN managed independently per access type, list of forbidden PLMNs for GPRS service, and the list of forbidden PLMNs for non-3GPP access to 5GCN. A PLMN may be added to a forbidden list, when the UE 102 receives a registration reject, a service reject, or a network initiated de-registration request, with cause value #74 (temporarily not authorized for this PLMN) or #75 (permanently not authorized for this PLMN). When the PLMN is in the plurality of forbidden lists, the UE 102 cannot select the PLMN, when operating in the not in SNPN access operation mode 106. Referring to the above-described example, the UE 102 may have PLMN 106c in the plurality of forbidden lists when operating in the not in SNPN access operation mode 106. As per current 3GPP specifications, the plurality of forbidden lists including the PLMN 106c may not be removed when the UE switches to the SNPN access operation mode 104. In such case, the UE 102 may not be able to select the PLMN 106c, when the UE 102 switches back to the not in SNPN access operation mode 106.

Herein, the UE 102 is configured to maintain the plurality of forbidden lists of the not in SNPN access operation mode 106 and execution of the timer initiated during the not in SNPN access operation mode 106, in the UE 102. Then, the UE 102 may remove the plurality of forbidden lists of the not in SNPN access operation mode 106, upon expiry of the timer in the SNPN access operation mode 104 or the not in SNPN access operation mode 106. In this way, the UE 102 is able to select the PLMN 106c, when operating in the not in SNPN access operation mode 106.

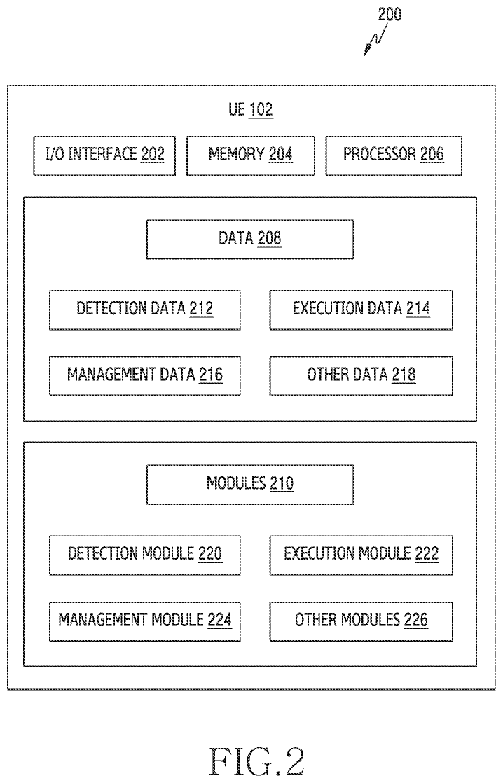

FIG. 2 is a diagram illustrating the UE 102 for managing switching between the access operation modes, according to an embodiment. Diagram 200 illustrates that the UE 102 may include central processing units (CPUs) (also referred as processor 206), an input/output (I/O) interface 202, and a memory 204. The memory 204 may be communicatively coupled to the processor 206. The memory 204 stores instructions executable by the processor 206. The processor 206 may comprise at least one data processor for executing program components for executing user or system-generated requests. The memory 204 may be communicatively coupled to the processor 206. The memory 204 stores instructions, executable by the processor 206, which, on execution, may cause the processor 206 to manage the switching between the access operation modes. In an embodiment, the memory 204 may include one or more modules 210 and data 208. The one or more modules 210 may be configured to perform the steps of the present disclosure using the data 208, to manage the switching between the access operation modes. Each of the one or more modules 210 may be a hardware unit which may be outside the memory 204 and coupled with the UE 102. As used herein, the term “modules” refers to an application specific integrated circuit (ASIC), an electronic circuit, a field-programmable gate array (FPGA), programmable system-on-chip (PSC), a combinational logic circuit, and/or other suitable components that provide described functionality. The one or more modules 210 when configured with the described functionality defined herein will result in a novel hardware. Further, the I/O interface 202 is coupled with the processor 206 through which an input signal or/and an output signal is communicated.

In one implementation, the modules 210 may include, for example, a detection module 220, an execution module 222, a management module 224, and other modules 226. The modules 210 may be represented as a single module or a combination of different modules. The data 208 may include, for example, detection data 212, execution data 214, management data 216, and other data 218.

In an embodiment, the detection module 220 may be configured to detect a switching of the UE 102 from the SNPN access operation mode 104 to the not in SNPN access operation mode 106. The UE 102 may be capable of operating in the SNPN access operation mode to access SNPN services. In such case, the UE 102 may be capable of operating in two modes (i.e., the SNPN access operation mode 104 and the not in SNPN access operation mode 106). Initially, the UE 102 may be operating in the SNPN access operation mode 104. The UE 102 may select an SNPN and complete registration to the SNPN by communicating with an AMF server. When the UE 102 is in a mobile state, the UE 102 may move out from the SNPN and the SNPN access operation mode 104 may be deactivated. The detection module 220 may detect the switching of the UE 102 from the SNPN access operation mode 104 to the not in SNPN access operation mode 106. In an example, a location of the UE 102 may be in a hospital which includes the SNPN services. The UE 102 may move out from the hospital. In such case, the SNPN access operation mode 104 may be deactivated.

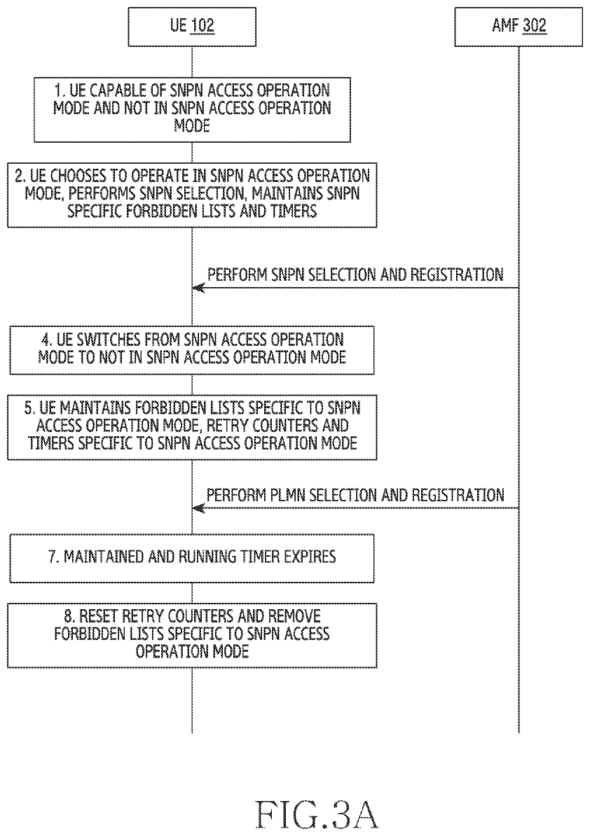

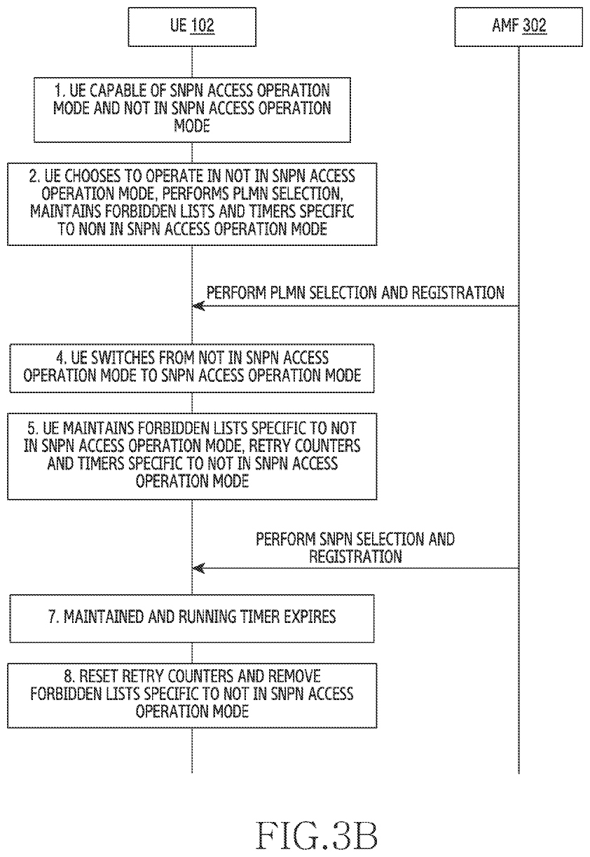

Referring to FIG. 3A, as shown in block 1, the UE 102 may be capable of operating in two modes (i.e., the SNPN access operation mode 104 and the not in SNPN access operation mode 106). As shown in block 2, the UE 102 may communicate with the AMF server 302 to perform the SNPN selection and registration. As shown in block 3, the detection module 220 may detect the switching of the UE 102 from the SNPN access operation mode 104 to the not in SNPN access operation mode 106.

In an embodiment, the detection module 220 may be configured to detect a switching of the UE 102 from the not in SNPN access operation mode 106 to the SNPN access operation mode 104. The UE 102 switches from the not in SNPN access operation mode 106 to the SNPN access operation mode 104 when the SNPN access operation mode 104 is activated.

Referring to FIG. 3B, as shown in block 1, the UE 102 may be capable of operating in two modes (i.e., the SNPN access operation mode 104 and the not in SNPN access operation mode 106). As shown in block 2, the UE 102 may communicate with the AMF server 302 to perform the PLMN selection and registration. As shown in block 3, the detection module 220 may detect the switching the UE 102 from the not in SNPN access operation mode 106 to the SNPN access operation mode 106. Referring back to FIG. 2, data related to detection of the switching between the access operation modes may be stored as the detection data 212 in the memory 204.

In an embodiment, the execution module 222 may be configured to receive the detection data 212 from the detection module 220. Further, the execution module 222 may be configured to maintain the plurality of forbidden lists of the SNPN access operation mode 104. The plurality of forbidden lists of the SNPN access operation mode 104 may include a permanently forbidden SNPNs list, a temporarily forbidden SNPNs list managed per access type independently, a permanently forbidden SNPNs list for network onboarding services, and a temporarily forbidden SNPNs list for network onboarding services. The execution module 222 may store the forbidden lists of the SNPN access operation mode 104 in the memory 204 of the UE 102.

Also, the execution module 222 may be configured to maintain execution of the timer initiated during the SNPN access operation mode 104, in the UE 102. The timer may include T3245. The execution module 222 may be configured to continue execution of the timer or running of the timer upon the switching. For example, the plurality of forbidden lists may include SNPN ‘2’. Also, a value of the timer may be 60 minutes. Considering that the timer executed for 40 minutes prior to the switching, the execution module 222 continues to execute the timer for next 20 minutes. Referring back to FIG. 3A, at block 5, the execution module 222 may maintain the plurality of forbidden lists of the SNPN access operation mode 104 and the timer specific to the SNPN access operation mode 104. Then, the UE 102 may perform the PLMN selection and registration upon maintaining the plurality of forbidden lists of the SNPN access operation mode 104 and the timer specific to the SNPN access operation mode 104.

Referring back to FIG. 2, in an embodiment, the execution module 222 may be configured to maintain the plurality of forbidden lists of the not in SNPN access operation mode 106, when the UE 102 switches from the not in SNPN access operation mode 106 to the SNPN access operation mode 104. The plurality of forbidden lists of the not in SNPN access operation mode 106 may include lists of forbidden PLMN managed independently per access type, a list of forbidden PLMNs for GPRS service and a list of forbidden PLMNs for non-3GPP access to 5GCN. The execution module 222 may store the forbidden lists of the not in SNPN access operation mode 106 in the memory 204 of the UE 102. Also, the execution module 212 may be configured to maintain execution of the timer initiated during the not in SNPN access operation mode 106, in the UE 102. The timer may include T3245. The execution module 222 may be configured to continue execution of the timer or running of the timer upon the switching.

Referring back to FIG. 3B, at block 5, the execution module 212 may maintain the plurality of forbidden lists of the not in SNPN access operation mode 106 and the timer specific to the not in SNPN access operation mode 106. Then, the UE 102 may perform the SNPN selection and registration upon maintaining the plurality of forbidden lists of the not in SNPN access operation mode 106 and the timer specific to the not in SNPN access operation mode 106.

Referring back to FIG. 2, the plurality of forbidden lists and an execution state of the timer may be stored as the execution data 214 in the memory 204.

In an embodiment, the management module 224 may be configured to manage the switching between the SNPN access operation mode 104 and the not in SNPN access operation mode 106. The management module 224 may be configured to remove the plurality of forbidden lists of the SNPN access operation mode 104, upon the expiry of the timer in the SNPN access operation mode 104 and the not in SNPN access operation mode 106. The management module 224 may reset any retry counters specific to the SNPN access operation mode 104, and remove the plurality of forbidden lists of the SNPN access operation mode 104, as shown in block 8 in FIG. 3A.

In an embodiment, the management module 224 may be configured to remove the plurality of forbidden lists of the not in SNPN access operation mode 106, upon the expiry of the timer in the SNPN access operation mode 104 and the not in SNPN access operation mode 106. The management module 224 may reset any retry counters specific to the not in SNPN access operation mode 106, and remove the plurality of forbidden lists of the not in SNPN access operation mode 106, as shown in block 8 in FIG. 3B.

The other data 218 may store data, including temporary data and temporary files, generated by the one or more modules 210 for performing the various functions of the UE 102. The one or more modules 210 may also include the other modules 226 to perform various miscellaneous functionalities of the UE 102. The other data 218 may be stored in the memory 204. The one or more modules 210 may be represented as a single module or a combination of different modules.

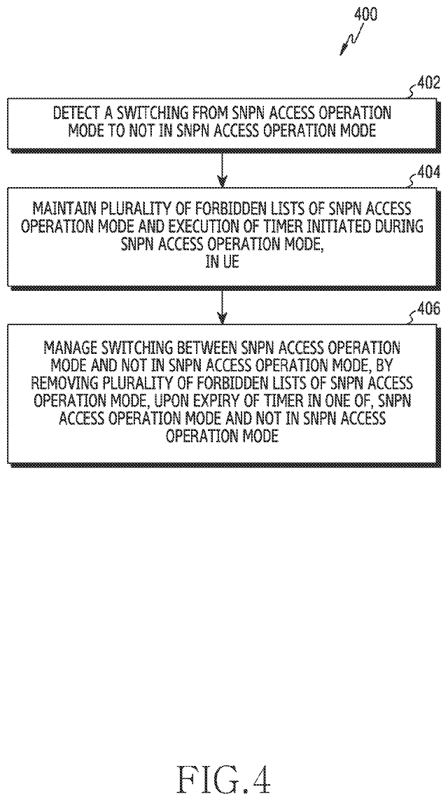

FIG. 4 is a flowchart illustrating a method for managing the switching of the UE 102 from the SNPN access operation mode 104 to the not in SNPN access operation mode 106, according to an embodiment. As illustrated in FIG. 4, a method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the method without departing from the scope of the subject matter described herein. Furthermore, the method can be implemented in any suitable hardware, software, firmware, or combination thereof.

At step 402, a switching from the SNPN access operation mode 104 to the not in SNPN access operation mode 106 is detected. The UE 102 switches from the SNPN access operation mode 104 to the not in SNPN access operation mode 106, when the SNPN access operation mode 104 is deactivated.

At step 404, the plurality of forbidden lists of the SNPN access operation mode 104 and execution of the timer initiated during the SNPN access operation mode 104 is maintained in the UE 102. The plurality of forbidden lists of the SNPN access operation mode 104 may include a permanently forbidden SNPNs list, a temporarily forbidden SNPNs list managed per access type independently, a permanently forbidden SNPNs list for network onboarding services, and a temporarily forbidden SNPNs list for network onboarding services.

At step 406, the switching between the SNPN access operation mode 104 and the not in SNPN access operation mode 106, by removing the plurality of forbidden lists of the SNPN access operation mode 104, upon the expiry of the timer in one of the SNPN access operation mode 104 and the not in SNPN access operation mode 106.

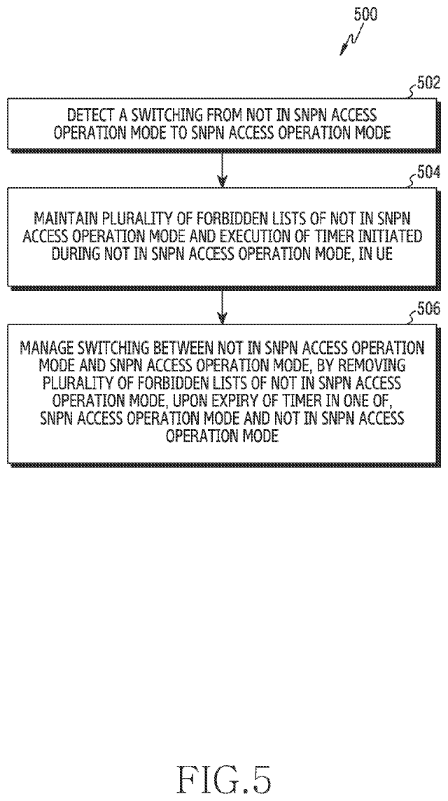

FIG. 5 is a flowchart illustrating a method for managing the switching of the UE 102 from the not in SNPN access operation mode 106 to the SNPN access operation mode 104, according to an embodiment. As illustrated in FIG. 5, a method 500 may include one or more steps. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 502, a switching from the not in SNPN access operation mode 106 to the SNPN access operation mode 104 is detected. The UE 102 switches from the not in SNPN access operation mode 106 to the SNPN access operation mode 104, when the SNPN access operation mode 104 is activated.

At step 504, the plurality of forbidden lists of the not in SNPN access operation mode 106 and execution of the timer initiated during the not in SNPN access operation mode 106 is maintained in the UE 102. The plurality of forbidden lists of the not in SNPN access operation mode 106 may include lists of forbidden PLMN managed independently per access type, a list of forbidden PLMNs for GPRS service, and a list of forbidden PLMNs for non-3GPP access to 5GCN.

At step 506, the switching between the SNPN access operation mode 104 and the not in SNPN access operation mode 106 is managed, by removing the plurality of forbidden lists of the not in SNPN access operation mode 106, upon the expiry of the timer in one of the SNPN access operation mode 104 and the not in SNPN access operation mode 106.

The illustrated operations of FIGS. 4 and 5 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

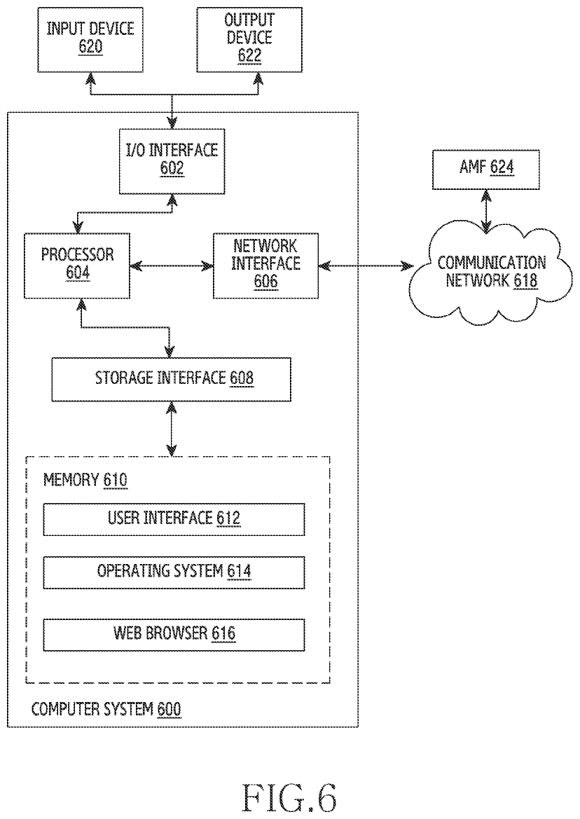

FIG. 6 is a diagram illustrating an exemplary computer system for implementing embodiments consistent with the present disclosure. In an embodiment, a computer system 600 may be the UE 102. Thus, the computer system 600 may be used to manage the switching between the access operation modes of the UE 102. The computer system 600 may communicate with an AMF 624, over a communication network 618. The computer system 600 may comprise a CPU (also referred as a processor 604). The processor 604 may comprise at least one data processor. The processor 604 may include specialized processing units such as integrated system (bus) controllers, memory management control units, floating point units, graphics processing units, digital signal processing units, etc.

The processor 604 may be disposed in communication with one or more I/O devices via an I/O interface 602. The I/O interface 602 may employ communication protocols/methods such as, without limitation, audio, analog, digital, monoaural, RCA, stereo, Institute of Electrical and Electronics Engineers (IEEE)-1394, serial bus, universal serial bus (USB), infrared, PS/2, BNC, coaxial, component, composite, digital visual interface (DVI), high-definition multimedia interface (HDMI), radio frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 602, the computer system 600 may communicate with one or more I/O devices. For example, an input device 620 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device 622 may be a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc.

The processor 604 may be disposed in communication with a communication network 618 via a network interface 606. The network interface 606 may communicate with the communication network 618. The network interface 606 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 618 may include, without limitation, a direct interconnection, local area network (LAN), wide area network (WAN), wireless network (e.g., using wireless application protocol (WAP)), the Internet, etc. The network interface 606 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 618 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, hypertext transfer protocol (HTTP), transmission control protocol/internet protocol (TCP/IP), WAP, etc., to communicate with each other. Further, the first network and the second network may include a variety of network devices, including routers, bridges, servers, computing devices, storage devices, etc.

In some embodiments, the processor 604 may be disposed in communication with a memory 610 (e.g., random access memory (RAM), read only memory (ROM), etc.) via a storage interface 608. The storage interface 608 may connect to memory 610 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 610 may store a collection of program or database components, including, without limitation, user interface 612, an operating system 614, web browser 616 etc. In some embodiments, the computer system 600 may store user/application data, such as, the data, variables, records, etc., as described herein. Such databases may be implemented as fault-tolerant, relational, scalable, secure databases such as Oracle® or Sybase®.

The operating system 614 may facilitate resource management and operation of the computer system 600. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 600 may implement the web browser 616 stored program component. The web browser 616 may be a hypertext viewing application, for example MICROSOFT® INTERNET EXPLORER™, GOOGLER CHROME™, MOZILLA® FIREFOX™, APPLE® SAFARI™, etc. Secure web browsing may be provided using secure hypertext transport protocol (HTTPS), secure sockets layer (SSL), transport layer security (TLS), etc. Web browsers 616 may utilize facilities such as AJAX™, DHTML™, ADOBE® FLASH™, JAVASCRIPT™, JAVA™, application programming interfaces (APIs), etc. In some embodiments, the computer system 600 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, NET™, CGI SCRIPTS™, JAVA™, JAVASCRIPT™, PERL™, PHP™, PYTHON™, WEBOBJECTS™, etc. The mail server may utilize communication protocols such as Internet message access protocol (IMAP), messaging application programming interface (MAPI), MICROSOFT® exchange, post office protocol (POP), simple mail transfer protocol (SMTP), or the like. In some embodiments, the computer system 600 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, non-volatile memory, hard drives, compact disc read-only memory (CD ROMs), digital video discs (DVDs), flash drives, disks, and any other known physical storage media.

The present disclosure provides a method and a UE of managing switching between access operation modes of the UE. The present disclosure provides a solution of maintaining forbidden lists of SNPNs or PLMNs when the UE switches between SNPN access operation mode and not in SNPN access operation mode. Also, the present disclosure provides a solution of maintaining execution of a timer initiated during the SNPN access operation mode or PLMN access operation mode, and deletion of respective forbidden lists, upon expiry of the timer irrespective of the access operation mode. Accordingly, the switching between the access operation modes of the UE is managed. The present disclosure enables the UE to select a SNPN or a PLMN present in the forbidden lists when the UE switches back to respective access operation mode.

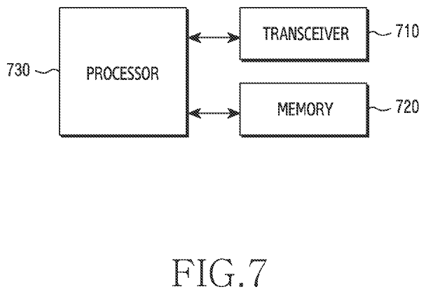

FIG. 7 is a diagram illustrating a structure of a UE, according to an embodiment.

As shown in FIG. 7, the UE may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor. Furthermore, the UE of FIG. 7 corresponds to the UE 102 of FIGS. 1 through 3B.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

The transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as ROM, RAM, a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

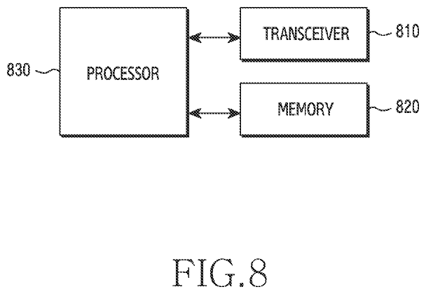

FIG. 8 is a diagram illustrating a structure of a base station according to an embodiment of the disclosure.

As shown in FIG. 8, the base station may include a transceiver 810, a memory 820, and a processor 830. The transceiver 810, the memory 820, and the processor 830 of the base station may operate according to a communication method of the base station described above. However, the components of the base station are not limited thereto. For example, the base station may include more or fewer components than those described above. In addition, the processor 830, the transceiver 810, and the memory 820 may be implemented as a single chip. Also, the processor 830 may include at least one processor. Furthermore, the base station of FIG. 8 corresponds to the BSs of FIG. 1.

The transceiver 810 collectively refers to a base station receiver and a base station transmitter, and may transmit/receive a signal to/from a terminal (UE) or a network entity. The signal transmitted or received to or from the terminal or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

The transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as ROM, RAM, a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

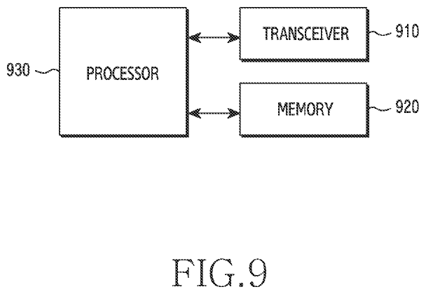

FIG. 9 is a diagram illustrating a structure of a network entity, according to an embodiment.

As shown in FIG. 9, the network entity may include a transceiver 910, a memory 920, and a processor 930. The transceiver 910, the memory 920, and the processor 930 of the network entity may operate according to a communication method of the network entity described above. However, the components of the terminal are not limited thereto. For example, the network entity may include more or fewer components than those described above. In addition, the processor 930, the transceiver 910, and the memory 920 may be implemented as a single chip. Also, the processor 930 may include at least one processor. Furthermore, the network entity illustrated in FIG. 9 may correspond to the network entity (e.g., AMF entity 302 in FIGS. 3A and 3B or AMF entity 624 in FIG. 6).

The transceiver 910 collectively refers to a network entity receiver and a network entity transmitter, and may transmit/receive a signal to/from a base station or a UE. The signal transmitted or received to or from the base station or the UE may include control information and data. In this regard, the transceiver 910 may include an RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the network entity. Also, the memory 920 may store control information or data included in a signal obtained by the network entity. The memory 920 may be a storage medium, such as ROM, RAM, a hard disk, a CD-ROM, and a DVD, or a combination of storage media.

The processor 930 may control a series of processes such that the network entity operates as described above. For example, the transceiver 910 may receive a data signal including a control signal, and the processor 930 may determine a result of receiving the data signal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in RAM, non-volatile memory including flash memory, ROM, electrically erasable programmable read-only memory (EEPROM), a magnetic disc storage device, CD-ROM, a DVD, another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a LAN, a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the above-described embodiments, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

At least some of the example embodiments described herein may be constructed, partially or wholly, using dedicated special-purpose hardware. Terms such as “component”, “module” or “unit” used herein may include, but are not limited to, a hardware device, such as circuitry in the form of discrete or integrated components, a FPGA or ASIC, which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

The specification has described a method and apparatus for selecting a selective security mode for applying selective security and flow management for selective security for User Equipment (UE) under mobility. Further, the specification has described a method and apparatus for flow management for selective security during the handover. The illustrated steps are set out to explain the embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### REFERRAL NUMERALS

| Referral Number | Description |
|---|---|
| 100 | Exemplary environment |
| 101 | UE |
| 102 | Network |
| 200 | Detailed diagram |
| 201 | I/O interface |
| 202 | Memory |
| 203 | Processor |
| 204 | Data |
| 205 | Modules |
| 206 | Session data |
| 207 | Measurement determination data |
| 208 | Temperature data |
| 209 | Transmission data |
| 210 | Other data |
| 211 | Session detection module |
| 212 | Determination module |
| 213 | Temperature detection module |
| 214 | Transmission module |
| 215 | Other modules |
| 600 | Computer system |
| 602 | I/O interface |
| 604 | Processor |
| 606 | Network interface |
| 608 | Storage interface |
| 610 | Memory |
| 612 | User interface |
| 614 | Operating system |
| 616 | Web browser |
| 618 | Communication network |
| 620 | Input device |
| 622 | Output device |
| 624 | AMF |

What is claimed is:

1. A method performed by a terminal in a wireless communication system, the method comprising:
storing information on a stand-alone non-public network (SNPN) in a plurality of lists of forbidden SNPN, while operating in an SNPN access operation mode;
deactivating the SNPN access operation mode; and
maintaining the plurality of lists of forbidden SNPN.

2. The method of claim 1, further comprising:
deleting the plurality of lists of forbidden SNPN, upon expiry of a timer,
wherein the timer comprises T3245.

3. The method of claim 1, wherein the plurality of lists of forbidden SNPN comprises a list of permanently forbidden SNPN and a list of temporarily forbidden SNPN.

4. The method of claim 1, wherein storing the information on the SNPN comprises:
selecting the SNPN while operating in the SNPN access operation mode,
wherein the information on the SNPN is included in a service reject message.

5. The method of claim 2, further comprising:
setting a selected entry or a selected public land mobile network (PLMN) subscription to valid for 3rd generation partnership project (3GPP) access and non-3GPP access; and
performing cell selection.

6. A method performed by a terminal in a wireless communication system, the method comprising:
storing information on a public land mobile network (PLMN) in a plurality of lists of forbidden PLMN;
activating a stand-alone non-public network (SNPN) access operation mode; and
maintaining the plurality of lists of forbidden PLMN.

7. The method of claim 6, further comprising:
deleting the plurality of lists of forbidden PLMN, upon expiry of a timer,
wherein the timer comprises T3245.

8. The method of claim 6, wherein the plurality of lists of forbidden PLMN comprises a list of forbidden PLMN and a list of forbidden PLMN for general packet radio service (GPRS).

9. The method of claim 6,
wherein storing the information on the PLMN comprises selecting the PLMN while not in the SNPN access operation mode, and
wherein the information on the PLMN is included in a registration reject message.

10. The method of claim 7, further comprising:
setting a universal subscriber identity module (USIM) of the terminal to valid for 5th generation system (5GS) service for 3rd generation partnership project (3GPP) access and non-3GPP access; and
performing cell selection.

11. A terminal in a wireless communication system, the terminal comprising:
a transceiver; and
a controller coupled with the transceiver and configured to:
store information on a stand-alone non-public network (SNPN) in a plurality of lists of forbidden SNPN;
deactivate an SNPN access operation mode; and
maintain the plurality of lists of forbidden SNPN.

12. The terminal of claim 11,
wherein the controller is further configured to delete the plurality of lists of forbidden SNPN, upon expiry of a timer, and
wherein the timer comprises T3245.

13. The terminal of claim 11, wherein the plurality of lists of forbidden SNPN comprises a list of permanently forbidden SNPN and a list of temporarily forbidden SNPN.

14. The terminal of claim 11, wherein the controller is further configured to:
select the SNPN while in the SNPN access operation mode,
wherein the information on the SNPN is included in a service reject message.

15. The terminal of claim 12, wherein the controller is further configured to:
set selected entry or selected public land mobile network (PLMN) subscription to valid for 3rd generation partnership project (3GPP) access and non-3GPP access; and
perform cell selection.

16. A terminal in a wireless communication system, the terminal comprising:
a transceiver; and
a controller coupled with the transceiver and configured to:
store information on a public land mobile network (PLMN) in a plurality of lists of forbidden PLMN;
activate a stand-alone non-public network (SNPN) access operation mode; and
maintain the plurality of lists of forbidden PLMN.

17. The terminal of claim 16,
wherein the controller is further configured to delete the plurality of lists of forbidden PLMN, upon expiry of a timer, and
wherein the timer comprises T3245.

18. The terminal of claim 16, wherein the plurality of lists of forbidden PLMN comprises a list of forbidden PLMN and a list of forbidden PLMN for general packet radio service (GPRS).

19. The terminal of claim 16, wherein the controller is further configured to:
select the PLMN while not in the SNPN access operation mode,
wherein the information on the PLMN is included in a registration reject message.

20. The terminal of claim 17, wherein the controller is further configured to:
set a universal subscriber identity module (USIM) of the terminal to valid for 5th generation system (5GS) service for 3rd generation partnership project (3GPP) access and non-3GPP access; and
perform cell selection.
